(19) United States
(12) Patent Application Publication
(10) Pub. No.: US 2021/0170932 A1
(43) Pub. Date: Jun. 10, 2021

(54) Composite Mat for Vehicles

(71) Applicants: Hyundai Motor Company, Seoul (KR); Kia Motors Corporation, Seoul (KR); SAMWOO TCS CO., LTD., Gyeongsangbuk-do (KR); HYUNDAI SYNTHETIC CO., LTD., Ansan-si (KR)

(72) Inventors: Hyung Gyu Park, Anyang-si (KR); Jai Hak Kim, Gunpo-si (KR); Sung Hui Kim, Daegu (KR); Min Jae Kang, Daegu (KR); Dong Hyeong Lee, Daego (KR); Si Yoon Kim, Hwaseong-si (KR); Joung Jun Cho, Siheung-si (KR); Min Seok Seo, Incheon (KR)

(21) Appl. No.: 16/994,841

(22) Filed: Aug. 17, 2020

(30) Foreign Application Priority Data
Dec. 5, 2019 (KR) 10-2019-0160988

(51) Int. Cl. B60N 3/04; B62D 25/20; B32B 5/02; B32B 3/12; B32B 27/40; B32B 27/12; B32B 3/02; B32B 7/12

(52) U.S. Cl. CPC B60N 3/048; B62D 25/2072; B60N 3/046; B32B 5/024; B32B 3/12; B32B 2262/101; B32B 27/12; B32B 3/02; B32B 7/12; B32B 2605/08; B32B 2471/04; B32B 27/40

(57) ABSTRACT

A composite mat for a vehicle is provided. The composite mat includes a composite material assembled to an upper surface of a floor module at a lower portion of a vehicle body, the composite material being configured by stacking a glass fiber mat and a polyurethane resin layer on a surface of a honeycomb layer, and a woven fabric layer stacked on the composite material such that the woven fabric layer is integrated with the composite material.

### CROSS-REFERENCE TO RELATED APPLICATIONS

This application claims priority to Korean Patent Application No. 10-2019-0160988, filed on Dec. 5, 2019, which application is hereby incorporated herein by reference.

### TECHNICAL FIELD

The present invention relates to a composite mat for a vehicle.

### BACKGROUND

A monocoque type vehicle body structure is applied to existing vehicles.

In such a monocoque type vehicle body structure, a lower structure of a vehicle body is completed by assembling a carpet, which is a combination of a non-woven fabric and a pad, to an upper surface of a lower frame in a vehicle body, in particular, at the lower portion of a center of the vehicle body, and assembling an undercover to a lower surface of the lower frame.

In order to complete such a lower vehicle body structure, elements such as a carpet and an undercover are separately manufactured, and are then assembled to a lower frame. For this reason, a large number of elements are required, and weight is increased and, as such, there may be a problem in that the number of assembly processes is excessively increased.

In particular, the lower structure of the vehicle body is completed by machining the elements through pressing using molds and welding the machined elements. For this reason, there is a drawback in that large-scale plant and equipment investment for a press factory, a vehicle body welding factory, a painting factory, etc. is required.

Furthermore, when various products should be manufactured in reduced numbers, increased design modification is required for production of elements of the products. For this reason, the number of molds is remarkably increased in this case and, as such, there is a problem of increased manufacturing costs.

Therefore, it is necessary to develop a new lower vehicle body structure capable of securing cost competitiveness through reduction of manufacturing costs and weight of the lower vehicle body structure while appropriately coping with a smart factory environment, thereby achieving an enhancement in ease of assembly of a vehicle body.

The above matters disclosed in this section are merely for enhancement of understanding of the general background of the invention and should not be taken as an acknowledgement or any form of suggestion that the matters form the related art already known to a person skilled in the art.

### SUMMARY

Embodiments of the present invention have been made in view of problems in the art, and embodiments of the present invention provide a composite mat for a vehicle capable of securing cost competitiveness while reducing the number of assembly processes through simplification of the lower structure of a vehicle body, thereby coping with a smart factory environment.

In accordance with an embodiment of the present invention, a composite mat for a vehicle is provided. The composite mat comprises a composite material assembled to an upper surface of a floor module at a lower portion of a vehicle body, the composite material being configured by stacking a glass fiber mat and a polyurethane resin layer on a surface of a honeycomb layer, and a woven fabric layer is stacked on the composite material such that the woven fabric layer is integrated with the composite material.

The composite material may be configured by sequentially stacking glass fiber mats and polyurethane resin layers on opposite surfaces of the honeycomb layer. The woven fabric layer may be stacked on one of the polyurethane resin layers, which forms an uppermost layer of the composite material.

An edge portion of the composite material may be formed to have a shape surrounded by the polyurethane resin layers.

One surface of the composite material may be seated on each fastening surface of frame members constituting floor modules of the lower portion of the vehicle body. A fastening reinforcing member may be inserted between a portion of the other surface of the composite material corresponding to the fastening surface and the woven fabric layer. A fastening member may extend through the woven fabric layer, the fastening reinforcing member and the composite material, and may be fastened to the fastening surface.

The composite material may be seated on each fastening surface of frame members constituting floor modules of the lower portion of the vehicle body. A cylindrical fastening reinforcing member may be inserted through the woven fabric layer and the composite material. A fastening member may extend through the fastening reinforcing member, thereby fastening the composite mat to the fastening surface.

Each of the frame members may be formed to have a tubular shape while having an opened cross-sectional structure with a side opening portion at one peripheral surface thereof. A mounting plate may be coupled between side closing sections respectively formed at opposite sides of the side opening portion. The composite material may be seated on and fastened to an upper surface of the mounting plate.

A flange may be formed at an end of each side closing section in accordance with folding of the end toward the side opening portion. A structural adhesive may be coated between the flange and the composite material.

An adhesive receiving groove, in which the structural adhesive is received, may be formed at the composite material to guide a path along which the structural adhesive is coated.

A step groove may be formed at an end of the composite material disposed adjacent to the adhesive receiving groove in the same plane as the adhesive receiving groove.

The structural adhesive may be coated between the composite material and the flange disposed inwardly of the vehicle body, as compared to a position where the fastening member is fastened.

A reinforcing member made of metal may be inserted between the composite material and the woven fabric layer.

Deformation guide members having a predetermined diameter may be inserted between the composite material and the woven fabric layer such that the deformation guide members form a lattice structure.

In accordance with embodiments of the present invention, the composite mat is simply assembled to a center floor module at the lower portion of the vehicle body, to configure a bottom surface of the lower portion of the vehicle body. Accordingly, the number of elements required to complete the lower structure of the vehicle body is reduced. Thus, it may be possible not only to secure cost competitiveness through reduction of the manufacturing costs and weight of the lower structure of the vehicle body, but also to enhance ease of assembly of the floor mat assembled to the lower portion of the vehicle body, and, as such, the composite mat may appropriately cope with a smart factory environment.

As the center floor mat and other mats disposed therebeneath are assembled to the frame members in a bolting manner in accordance with embodiments of the present invention, the lower portion of the vehicle body is completed. Accordingly, the lower portion of the vehicle body does not require large-scale pressing, vehicle body welding, and painting factories and, as such, may appropriately cope with a smart factory environment. In addition, the assembly process of the vehicle body may be simplified and, as such, ease of assembly may be enhanced.

### BRIEF DESCRIPTION OF THE DRAWINGS

The above and other objects, features and other advantages of embodiments of the present invention will be more clearly understood from the following detailed description taken in conjunction with the accompanying drawings, in which:

FIG. 1 is a view illustrating a composite mat according to a preferred embodiment of the present invention in a state in which layers of the composite mat are exploded;

FIG. 2 is a view illustrating an integrated structure of the composite mat according to the preferred embodiment of the present invention;

FIG. 3 is a view illustrating a center floor mat prepared using the composite mat according to the illustrated embodiment of the present invention;

FIG. 4 is a view illustrating a vehicle body shape applicable to the center floor mat of FIG. 3;

FIG. 5 is a view illustrating an assembled state of the center floor mat of FIG. 3 to a lower portion of a vehicle body;

FIG. 6 is a view showing a cross-section of a portion A of FIG. 5 corresponding to an edge portion of the center floor mat;

FIG. 7 is a cross-sectional view taken along line B-B of FIG. 5;

FIG. 8 is a cross-sectional view taken along line C-C of FIG. 5;

FIG. 9 is a view illustrating a structure in which a dash mat and the center floor mat are assembled in the case of FIG. 8;

FIG. 10 is a cross-sectional view taken along line D-D of FIG. 5;

FIG. 11 is a view illustrating a position where a structural adhesive is bonded to the center floor mat in accordance with an embodiment of the present invention;

FIGS. 12 to 14 are views illustrating positions where a reinforcing member is applied to the center floor mat in accordance with embodiments of the present invention, respectively;

FIG. 15 is a view illustrating a state in which deformation guide members are applied to the center floor mat 100 in accordance with an embodiment of the present invention;

FIG. 16 is a view showing cross-sections respectively taken along lines E-E and E′-E′ of FIG. 15;

FIG. 17 is a view explaining manufacture of a frame member according to an embodiment of the present invention; and

FIG. 18 is a view showing a state in which a cylindrical fastening reinforcing member is applied and fastened to the center floor mat in accordance with another embodiment of the present invention.

### DETAILED DESCRIPTION OF ILLUSTRATIVE EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

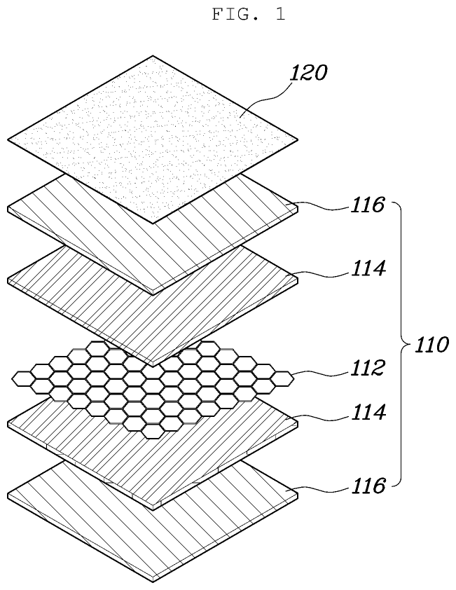

Referring to FIG. 1, a composite mat 100 for vehicles according to a preferred embodiment of the present invention, which is applicable to a lower portion of a vehicle body 10 in a miniature electric vehicle, is shown. A center floor mat may be manufactured using the composite mat 100, which is configured by a plurality of stacked layers. The center floor mat may be assembled to the lower portion of the vehicle body 10.

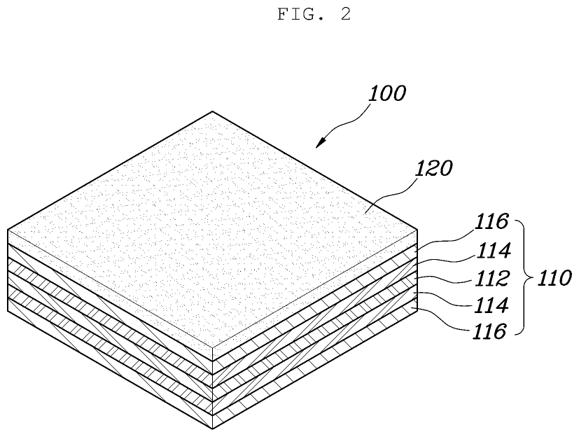

FIG. 1 is a view illustrating the composite mat 100 according to a preferred embodiment of the present invention in a state in which layers of the composite mat 100 are exploded. FIG. 2 is a view illustrating an integrated structure of the composite mat 100 according to a preferred embodiment of the present invention.

Referring to the drawings, in accordance with a preferred embodiment of the present invention, the composite mat 100 is configured by bonding a woven fabric layer 120 to a composite material 110. The composite material 110 is assembled to an upper surface of a floor module at the lower portion of the vehicle body 10. The composite material 110 is configured by sequentially stacking a glass fiber mat 114 and a polyurethane resin layer 116 on each of opposite surfaces of a honeycomb layer 112.

The woven fabric layer 120 is stacked on the composite material 110 such that the woven fabric layer 120 is integrated with the composite material 110 and, as such, the composite mat 100 is manufactured.

In this case, the honeycomb layer 112 has a honeycomb structure. The honeycomb layer 112 may be made of polypropylene (PP). The woven fabric layer 120 may be a carpet which is a kind of woolen fabric.

For reference, the composite material 110, which constitutes the composite mat 100, may be produced through foaming. The composite material 110 may be produced while having different thicknesses in accordance with different molding conditions. Preferably, the composite material 110 is formed to have a thickness of about 7 t, and the woven fabric layer 120 is formed to have a thickness of about 1 to 3 t.

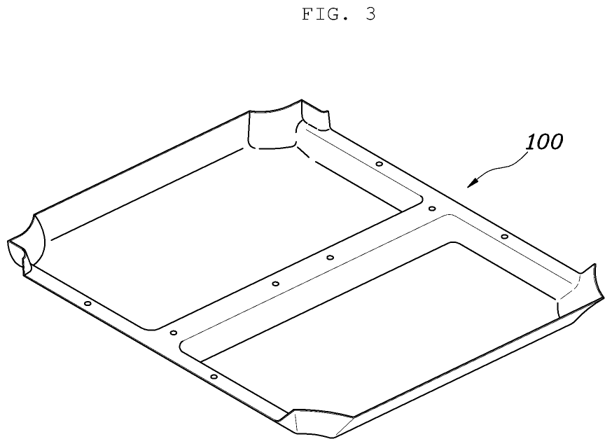

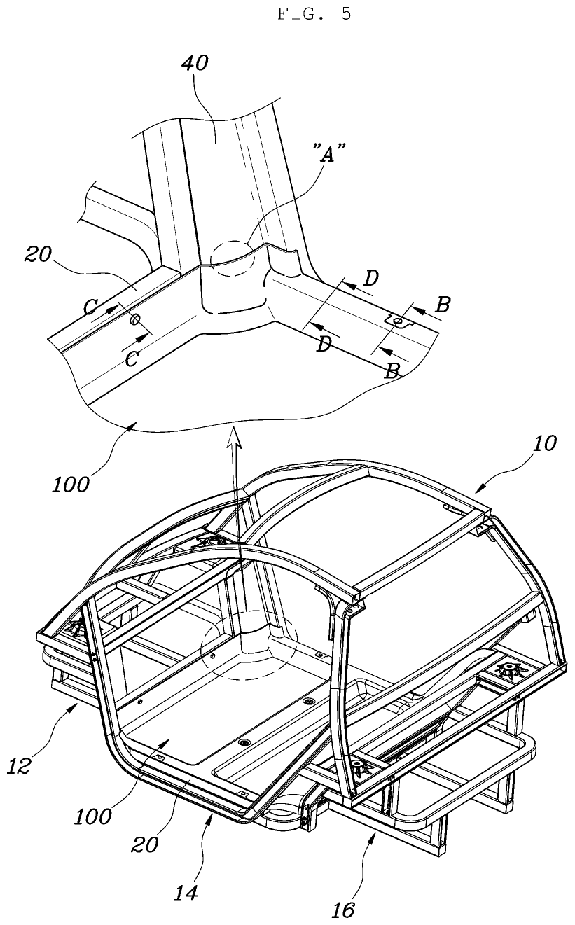

That is, the composite mat 100 may be manufactured by stacking the woven layer 120 on the composite material 110 configured through stacking of the honeycomb layer 112, the glass fiber mats 114 and the polyurethane resin layers 116. Using the composite mat 100 manufactured as described above, a center floor mat for the lower portion of the vehicle body may be prepared, as shown in FIGS. 3 and 5. The center floor mat, which is designated by the same reference numeral as the composite mat 100, that is, the center floor mat 100, may be assembled to a center floor module 14 supporting the lower portion of the vehicle body 10.

In accordance with a preferred embodiment of the present invention, a floor surface of the lower portion of the vehicle body 10 is configured through simple assembly of the composite mat 100 to the center floor module 14 at the lower portion of the vehicle body 10, as described above. Accordingly, the number of elements needed to configure a lower structure of the vehicle body 10 may be reduced. Thus, it may be possible not only to secure cost competitiveness through reduction in manufacturing costs and weight, but also to enhance ease of assembly of the floor mat assembled to the lower portion of the vehicle body 10, and, as such, the composite mat may appropriately cope with a smart factory environment.

For reference, a front floor module 12 is connected to a front portion of the center floor module 14, and a rear floor module 16 is connected to a rear portion of the center floor module 14. Spaces may be formed at connecting portions of the center floor module 14 to the front and rear floor modules 12 and 16, in particular, corner portions of the center floor module 14. Due to such spaces, the center floor module 14 may have portions which cannot support the center floor mat 100. To this end, reinforcing plates 40 are additionally connected to respective corner portions in an attached manner, not only to enhance rigidity of the corner portions, but also to enable the center floor mat 100 to be assembled to the corner portions while being supported by the reinforcing plates 40.

In addition, it may be possible to prepare a dash mat to be assembled to a dash module and a rear floor mat to be assembled to the rear floor module 16, as well as the center floor mat 100. These mats may be assembled to the associated modules in the same assembly manner as the center floor mat, respectively.

Hereinafter, the structure of the composite mat 100 according to a preferred embodiment of the present invention will be described with reference to FIGS. 1 and 2. The composite material 110 is configured by sequentially stacking the glass fiber mat 114 and the polyurethane resin layer 116 on each of opposite surfaces of the honeycomb layer 112.

The woven fabric layer 120 is then stacked on the polyurethane resin layer 116 such that the woven fabric layer 120 is integrated with the polyurethane resin layer 116.

In this case, as shown in the drawings, the woven fabric layer 120 may be stacked only on the polyurethane resin layer 116 at one side with reference to the honeycomb layer 112. Alternatively, the woven fabric layer 120 may be stacked on each of the polyurethane resin layers 116 at both sides with reference to the honeycomb layer 112.

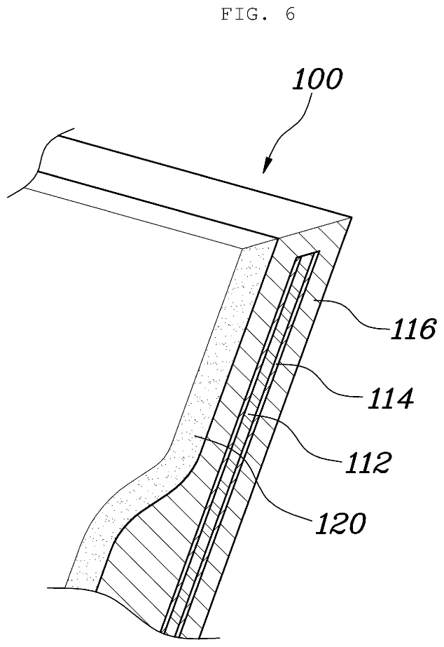

Meanwhile, FIG. 6 is a view showing an edge portion of the center floor mat 100 prepared using the composite mat 100 according to embodiments of the present invention.

Referring to FIG. 6, an edge portion of the composite material 110 may be formed to have a shape surrounded by the polyurethane resin layers 116.

That is, the glass fiber mats 114 are disposed inside the composite material 110 and, as such, an overlap structure is applied to the edge portion of the composite material 110 such that the edge portion of the composite material 110 is surrounded by the polyurethane resin layer 116. Accordingly, formation and dispersion of glass fiber dust may be prevented.

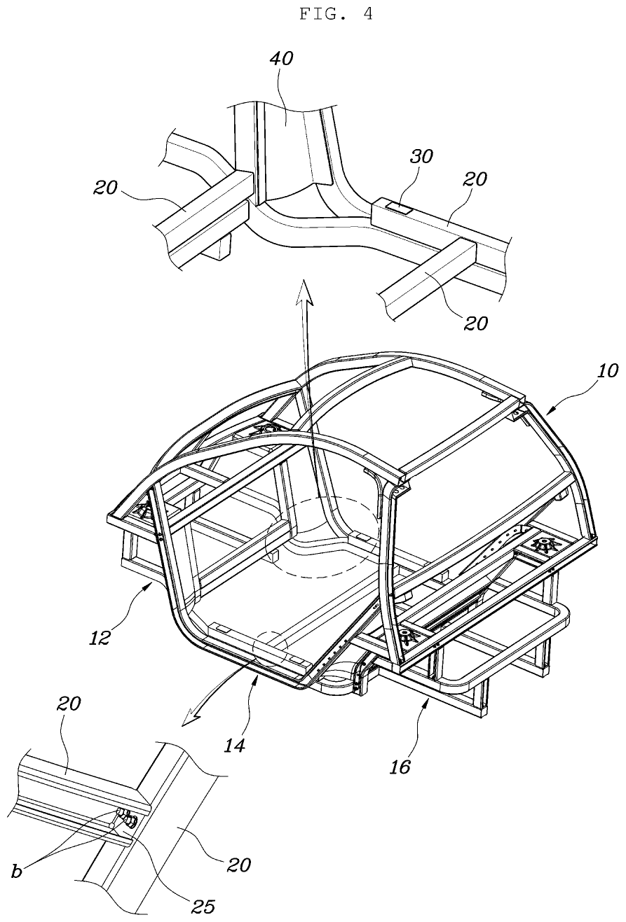

Meanwhile, FIG. 4 is a view showing a shape of the vehicle body 10 to which the center floor mat 100 according to an embodiment of the present invention is applicable. FIG. 5 is a view showing an assembled state of the center floor mat 100 to the lower portion of the vehicle body 10.

Referring to FIGS. 4, 5 and 7, one surface of the composite material 110 is seated on each fastening surface of frame members 20 constituting the floor modules of the lower portion of the vehicle body 10. A fastening reinforcing member 130 is inserted between a portion of the other surface of the composite material 110 corresponding to each fastening surface and the woven fabric layer 120.

A fastening member b extends through the woven fabric layer 120, the fastening reinforcing member 130 and the composite material 110, and is fastened to the fastening surface.

The frame members 20 constitute, for example, the center floor module 14 at the lower portion of the vehicle body 10 through assembly thereof. In this case, the center floor module 14 is formed to have a substantially quadrangular shape and, as such, the center floor mat 100 is prepared to have a shape covering the center floor mat 100, that is, a quadrangular shape.

In this case, opposite lateral ends and a rear end of the center floor mat 100 are assembled in a fastened manner to upper surfaces of the opposite side frame members 20 and the rear frame member 20, which constitute the center floor module 14. A front end of the center floor mat 100 is assembled in a fastened manner to a lower surface of the frame member 20 disposed at a front side of the center floor module 14.

In particular, the fastening reinforcing member 130 may be manufactured to have a shape of a washer made of stainless steel. The fastening reinforcing member 130 is inserted between the woven fabric layer 120 and the composite material 110 in foaming of the center floor mat 100 and, as such, may be fixed.

That is, in the case in which the center floor mat 100 is directly fastened to each frame member 20, degradation of durability may occur when a crack is formed due to a fastening torque caused by the fastening member b or a load at an associated fastening area.

To this end, in accordance with an embodiment of the present invention, the washer-shaped fastening reinforcing member 130 inserted into the inside of the center floor mat 100 is configured to support a fastening load of the fastening member b. Accordingly, the load applied to each fastening area is distributed by the associated fastening reinforcing member 130 and, as such, a stable fastening structure may be realized.

In addition, the fastening reinforcing member 130 is fastened in a pressed state by the fastening member b and, as such, the associated fastening area is reduced in thickness, thereby achieving enhancement in fastening rigidity and dimensional stability.

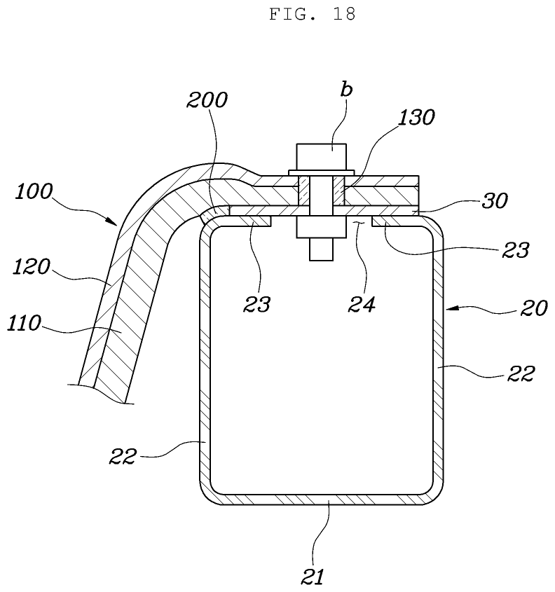

Meanwhile, FIG. 18 is a view showing a structure of the center floor mat 100 assembled to the lower portion of the vehicle body 10 in accordance with another embodiment of the present invention.

Referring to FIG. 18, the composite material 110 is seated on each fastening surface of the frame members 20 constituting the floor modules of the lower portion of the vehicle body 10. A cylindrical fastening reinforcing member 130 is inserted into through holes formed through the woven fabric layer 120 and the composite material 110.

A fastening member b extends through the fastening reinforcing member 130 and, as such, the composite mat 100 is fastened to the fastening surface.

For example, the fastening reinforcing member 130 may be a cylindrical insert nut. The fastening reinforcing member 130 extends in a cross-sectional direction of the center floor mat 100, and is bonded to the center floor mat 100, and as such, a structure in which an outer circumferential surface of the fastening reinforcing member 130 is surrounded by the center floor mat 100 is formed.

That is, when the fastening reinforcing member 130 is a cylindrical insert nut, threads of a bolt used as the fastening member b contact an inner circumferential surface of the insert nut, and the outer circumferential surface of the insert nut is completely surrounded by an inner surface of the through hole of the center floor mat 100 while contacting the inner surface of the through hole. Accordingly, dispersion of glass fibers constituting the composite material 110 may be prevented.

In accordance with the above-described structure, a fastening torque is generated between a head portion of the bolt and the insert nut in accordance with thread fastening of the threads of the bolt during bolting of the bolt. Accordingly, a stable fastening structure may be formed by the fastening reinforcing member 130 at the associated fastening area.

For reference, the fastening member b may be a bolt/nut. In this case, each fastening area may be fastened in a bolting manner.

In this case, the center floor mat 100 and other mats disposed therebeneath are assembled to the frame members 20 in a bolting manner and as such, the lower portion of the vehicle body 10 is completed. In this regard, the lower portion of the vehicle body 10 does not require large-scale pressing, vehicle body welding, and painting factories and, as such, may appropriately cope with a smart factory environment. In addition, the assembly process of the vehicle body 10 may be simplified and, as such, ease of assembly may be enhanced.

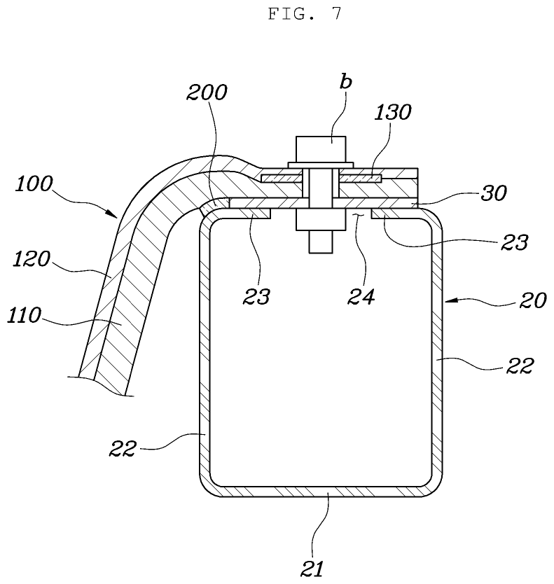

FIG. 7 is a view showing a cross-section of an area where the center floor mat 100 is assembled to one frame member 20.

Referring to FIG. 7, the frame member 20 is formed to have a tubular shape while having an opened cross-sectional structure with a side opening portion 24 at one peripheral surface thereof. A mounting plate 30 is coupled between side closing sections 22 respectively formed at opposite sides of the side opening portion 24.

Accordingly, the composite material 110 may be seated on and fastened to an upper surface of the mounting plate 30.

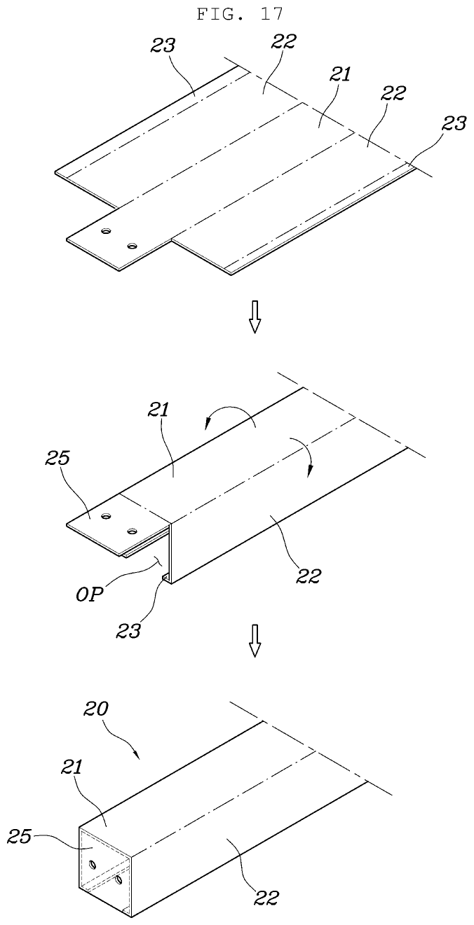

For example, as illustrated in FIG. 17, the frame member 20, to which the center floor mat 100 is fastened, is a tube having an opened cross-sectional structure having one opened surface. That is, the frame member 20 is formed to have a “U”-shaped cross-section perpendicular to a longitudinal direction thereof and, as such, has a structure in which three of the peripheral surfaces of the frame member 20 are closed, and the remaining one peripheral surface is opened.

In addition, a fastening portion 25 having a longitudinal extension shape is formed at an end of a side connecting section 21. The fastening portion 25 is folded toward a corresponding end of the frame member 20 and, as such, is fixed to the end of the frame member 20 while closing an opening OP at the end of the frame member 20.

That is, the side closing sections 22, which are respectively connected to opposite side edges of the side connecting section 21 facing the side opening portion 24 among the three closed peripheral surfaces of the frame member 20, are folded in a direction perpendicular to the side connecting section 21 and, as such, the frame member 20 has a “U”-shaped structure.

Since the center floor mat 100 should be assembled to the side opening portion 24 of the “U”-shaped frame member 20, a separate mounting plate 30 is assembled between the opposite side closing sections 22.

Accordingly, an upper surface of the mounting plate 30 serves as a fastening surface and, as such, the center floor mat 100 is coupled to the upper surface of the mounting plate 30. Thus, the mounting plate 30 not only provides a mounting seat surface of the center floor mat 100, but also prevents divergence or convergence of the opposite side closing sections 22, thereby securing torsional rigidity of the opposite side closing sections 22.

For reference, as shown in FIG. 4, the fastening portion 25 is fastened to another frame member 20 by fastening members b under the condition that the fastening portion 25 is in surface contact with the other frame member 20. In accordance with such an assembly method, a frame of the vehicle 10 is completed.

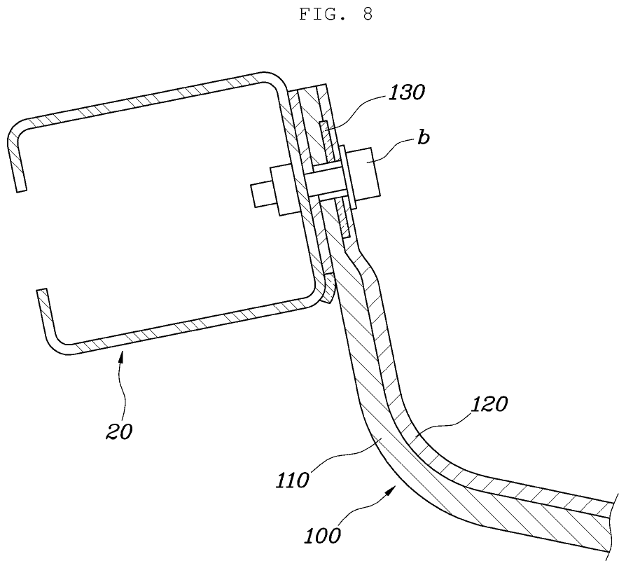

FIG. 8 is a cross-sectional view taken along line C-C of FIG. 5. Referring to FIG. 8, the center floor mat 100 is assembled to the frame member 20 under the condition that a matching surface angle of the frame member 20 is adjusted to be matched with a shaping angle of the center floor mat 100.

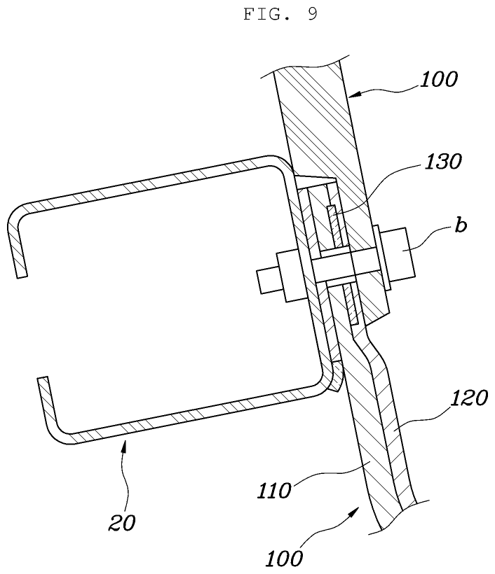

In addition, FIG. 9 is a view illustrating a structure in which a dash mat is assembled to the frame member 20, together with the center floor mat 100, in the case of FIG. 8. The dash mat may be coupled to the frame member 20 through bolting under the condition that the dash mat overlaps with the center floor mat 100. Although not shown, a rear floor mat may be coupled to a rear end of the center floor mat 100 through bolting under the condition that the rear floor mat overlaps with the center floor mat 100.

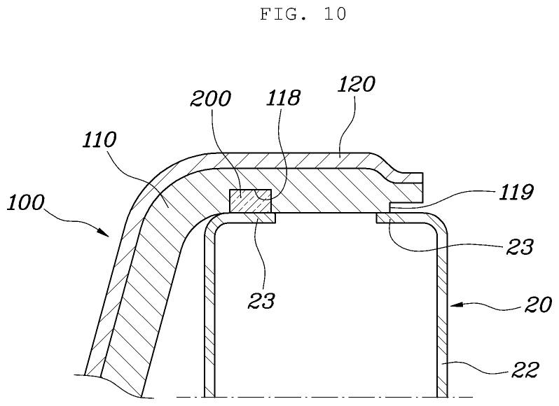

Meanwhile, FIG. 10 is a cross-sectional view taken along line D-D of FIG. 5.

Referring to FIG. 10 together with FIG. 7, an end of each side closing section 22 is folded toward the side opening portion 24, thereby forming a flange 23. A structural adhesive 200 is coated between the flange 23 of one side closing section 22 and the composite material 110.

For example, ends of the opposite side closing sections 22 may be folded in facing directions, thereby forming flanges 23, respectively.

That is, each flange 23 is formed to have a shape bent from the corresponding side closing section 22 toward the side opening portion 24 and, as such, secures rigidity at the end of the side closing section 22 while serving to provide a seat surface on which the mounting plate 30 is mounted.

In particular, the structural adhesive 200 is coated on a planar surface of the flange 23 extending in a width direction and, as such, the flange 23 serves as a sealing surface for the structural adhesive 200.

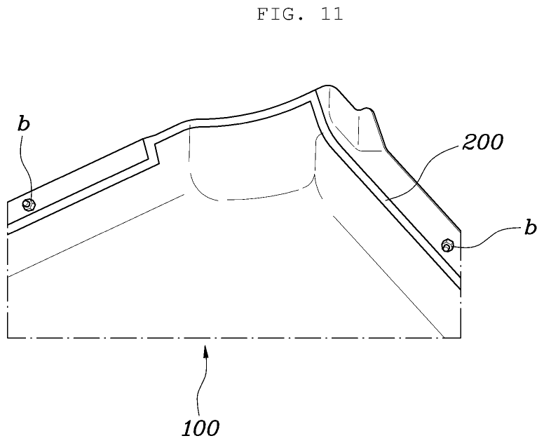

FIG. 11 is a view illustrating a position where the structural adhesive 200 is bonded to the center floor mat 100 in accordance with an embodiment of the present invention.

Referring to FIG. 11 together with FIG. 10, an adhesive receiving groove 118, in which the structural adhesive 200 is received, may be formed at the composite material 110 to guide a path along which the structural adhesive 200 is coated.

That is, in accordance with embodiments of the present invention, the center floor mat 100 is fastened alone to the frame members 20 constituting a floor module through bolting, or is fastened in common to the frame members 20, together with another floor mat, through bolting.

However, in matching areas except for the fastening area, sealing is required. Accordingly, a sealing task for the matching areas is carried out using the structural adhesive 200.

In connection with this, in accordance with an embodiment of the present invention, the structural adhesive 200, which is of a foam type, may be used. As the adhesive receiving groove 118, which has an engraved shape, is formed in an area where the structural adhesive 200 will be applied, it may be possible to correctly coat the structural adhesive 200 over the application area.

In addition, in accordance with an embodiment of the present invention, a step groove 119 may be formed at an end of the composite material 110 disposed adjacent to the adhesive receiving groove 118 in the same plane as the adhesive receiving groove 118.

That is, the step groove 119 is formed at the end of the composite material 110 disposed adjacent to the area where the structural adhesive 200 is applied such that the step groove 119 has a height corresponding to a depth of the adhesive receiving groove 118. Accordingly, it may be possible to prevent loosening of the composite material 110 due to the weight thereof during curing of the structural adhesive 200, thereby securing dimensional stability.

In addition, the structural adhesive 200 may be coated between the composite material 110 and the flange 23 disposed inwardly of the vehicle body 10, as compared to a position where the fastening member b is fastened.

That is, as the structural adhesive 200 is coated over the flange disposed inwardly of the area where the composite mat 100 and the frame member 20 are fastened through bolting, moisture sealing is maintained by the structural adhesive 200 even when moisture penetrates into bolting portions of the composite mat 100 and the frame member 20. As a result, penetration of moisture into the interior of the vehicle body 10 may be prevented by the structural adhesive 200.

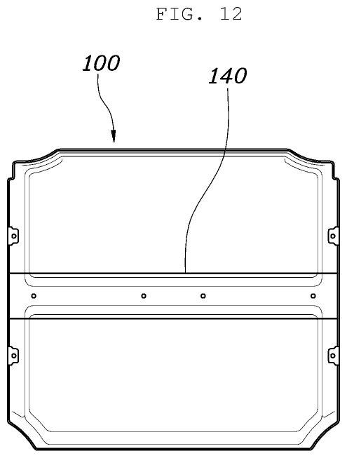

Meanwhile, FIGS. 12 to 14 are views illustrating positions where a reinforcing member 140 is applied to the center floor mat 100 in accordance with embodiments of the present invention.

Referring to FIGS. 12 to 14, the reinforcing member 140, which is made of metal, may be inserted between the composite material 110 and the woven fabric layer 120.

For example, in the case of FIG. 12, the reinforcing member 140, which is made of stainless steel, is inserted into an area where the center floor mat 100 is fastened through bolting to the frame members 20 joined in a lateral direction at a middle portion of the center floor module 14. In this case, rigidity and strength at the reinforcing area are enhanced and, as such, collision performance may be enhanced.

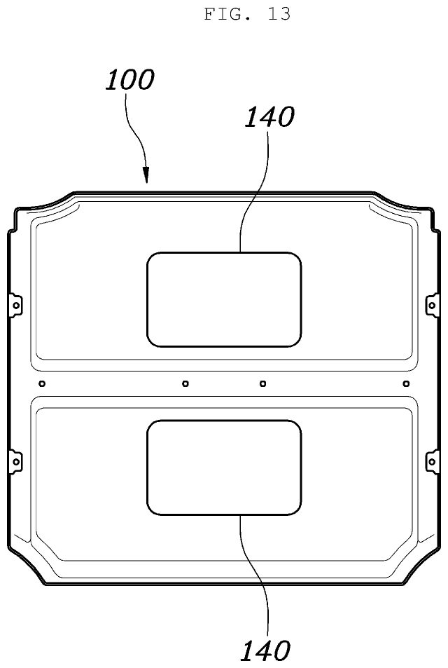

In the case of FIG. 13, an aluminum sheet is inserted into each planar floor portion of the center floor mat 100. In this case, thermal insulation performance at the corresponding reinforcing area may be enhanced.

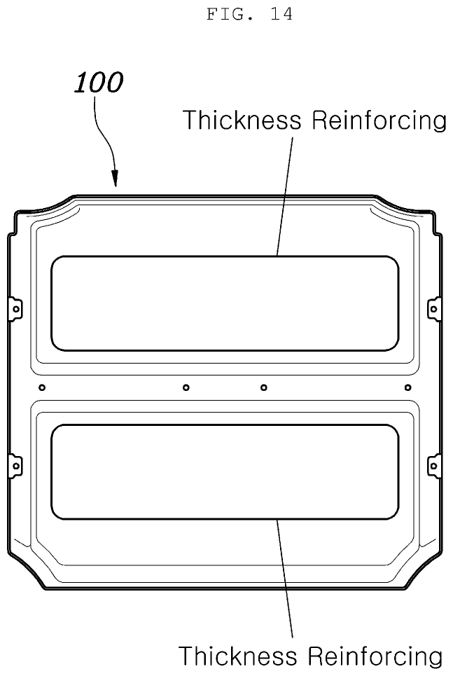

In the case of FIG. 14, the thickness of the carpet at each planar floor portion of the center floor mat 100 is increased. In this case, vibration and noise is reduced by the corresponding reinforcing area and, as such, noise, vibration and harshness (NVH) performance may be enhanced.

Thus, in accordance with embodiments of the present invention, the reinforcing member 140, which may be made of different materials in accordance with target performance of the composite mat 100, is inserted and molded during foaming of the composite mat 100 and, as such, collision performance and sound absorption and insulation/thermal insulation performance may be separately provided at desired areas.

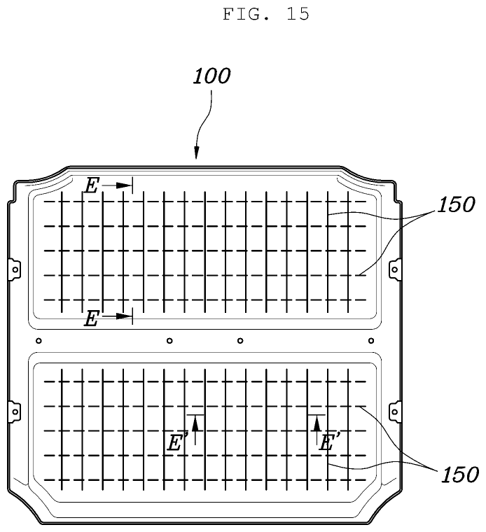

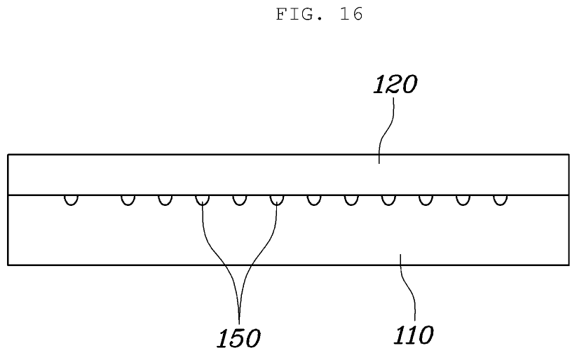

FIG. 15 is a view illustrating a state in which deformation guide members 150 are applied to the center floor mat 100 in accordance with an embodiment of the present invention. FIG. 16 is a view showing cross-sections respectively taken along lines E-E and E′-E′ of FIG. 15. For reference, the cross-section taken along line E-E and the cross-section taken along line E′-E′ may be shown to have the same cross-sectional shape.

Referring to FIGS. 15 and 16, the deformation guide members 150, which have a predetermined diameter, may be inserted between the composite material 110 and the woven fabric layer 120 such that the deformation guide members 150 form a lattice structure.

That is, the center floor mat 100 prepared by the composite mat 100 may exhibit non-uniform deformation directions upon collision of the vehicle due to application of the composite material 110 which has a multilayer structure.

To this end, the deformation guide members 150, which have a constant diameter, are inserted while being uniformly spaced apart from one another in longitudinal and lateral directions and, as such, may uniformly guide collision deformation upon front/side collision of the vehicle.

Meanwhile, in accordance with embodiments of the present invention, the fastening reinforcing member 130 is inserted between the multilayer composite material 110 and the woven fabric layer 120 in the composite mat 100 such that the fastening reinforcing member 130 is integrated with the composite material 110 and the woven fabric layer 120.

Accordingly, the composite mat 100 may be seated on each fastening surface of the frame members 20 constituting the floor module of the lower portion of the vehicle body 10, and the composite mat 100 may be fastened to the fastening surface in accordance with extension of the fastening member b through the woven fabric layer 120, the fastening reinforcing member 130 and the composite material 110.

As the washer-shaped reinforcing fastening member 130, which is inserted into the composite mat 100, is configured to support a fastening load of the fastening member b, a stable fastening structure may be realized by the fastening reinforcing member 130. In addition, when the fastening reinforcing member is formed to have a cylindrical shape, it may be possible to prevent the possibility of dispersion of glass fibers occurring at the composite material 110 in the area where the fastening reinforcing member 130 is fastened.

Hereinafter, a method for coupling the composite mat 100 to each frame member 20 through bolting will be described with reference to FIG. 7. First, a portion of the composite mat 100, which should be fastened to the upper surface of the mounting plate 30 joined to the frame member 20, is seated on the upper surface of the mounting plate 30.

In this case, bolting holes may be formed at the mounting plate 30 and the composite mat 100, respectively. In connection with this, the composite mat 100 is seated on the mounting plate 30 in a state in which the bolting holes are aligned with each other.

Thereafter, a bolt is coupled to the bolting holes. Since the frame member 20 is opened at one peripheral surface thereof, a nut is inserted through the opened side opening portion 24, and the bolt is then fastened using a tool. Thus, an assembly task of the composite mat 100 and the frame member 20 may be conveniently and simply carried out.

As the center floor mat 100 and other mats disposed therebeneath are assembled to the frame members 20 in a bolting manner in accordance with embodiments of the present invention, the lower portion of the vehicle body lo is completed. Accordingly, the lower portion of the vehicle body 10 does not require large-scale pressing, vehicle body welding, and painting factories and, as such, may appropriately cope with a smart factory environment. In addition, the assembly process of the vehicle body 10 may be simplified and, as such, ease of assembly may be enhanced.

In particular, the composite mat 100 is simply assembled to the center floor module 14 at the lower portion of the vehicle body lo in accordance with embodiments of the present invention, to configure a bottom surface of the lower portion of the vehicle body 10. Accordingly, the number of elements required to complete the lower structure of the vehicle body 10 is reduced. Thus, it may be possible not only to secure cost competitiveness through reduction of the manufacturing costs and weight of the lower structure of the vehicle body 10, but also to enhance ease of assembly of the floor mat assembled to the lower portion of the vehicle body 10, and, as such, the composite mat may appropriately cope with a smart factory environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composite mat for a vehicle, the composite mat comprising:
a composite material assembled to an upper surface of a floor module at a lower portion of a vehicle body, the composite material being configured by stacking a glass fiber mat and a polyurethane resin layer on a surface of a honeycomb layer; and
a woven fabric layer stacked on the composite material such that the woven fabric layer is integrated with the composite material.

2. The composite mat according to claim 1, wherein:
the composite material comprises a first glass fiber mat and a first polyurethane resin layer stacked on a first surface of the honeycomb layer and a second glass fiber mat and a second polyurethane resin layer stacked on a second surface of the honeycomb layer, the second surface being opposite the first surface; and
the woven fabric layer is stacked on one of the first and second polyurethane resin layers to form an uppermost layer of the composite material.

3. The composite mat according to claim 2, wherein an edge portion of the composite material is formed to have a shape surrounded by the first and second polyurethane resin layers.

4. The composite mat according to claim 1, wherein:
a first surface of the composite material is seated on each fastening surface of frame members constituting floor modules of the lower portion of the vehicle body;
a fastening reinforcing member is inserted between a portion of a second surface of the composite material corresponding to the fastening surface and the woven fabric layer; and
a fastening member extends through the woven fabric layer, the fastening reinforcing member and the composite material, and is fastened to the fastening surface.

5. The composite mat according to claim 1, wherein:
the composite material is seated on each fastening surface of frame members constituting floor modules of the lower portion of the vehicle body;
a cylindrical fastening reinforcing member is inserted through the woven fabric layer and the composite material; and
a fastening member extends through the fastening reinforcing member, thereby fastening the composite mat to the fastening surface.

6. The composite mat according to claim 5, wherein:
each of the frame members is formed to have a tubular shape while having an opened cross-sectional structure with a side opening portion at one peripheral surface thereof;
a mounting plate is coupled between side closing sections respectively formed at opposite sides of the side opening portion; and
the composite material is seated on and fastened to an upper surface of the mounting plate.

7. The composite mat according to claim 6, further comprising:
a flange formed at an end of each side closing section in accordance with folding of the end toward the side opening portion; and
a structural adhesive coated between the flange and the composite material.

8. The composite mat according to claim 7, wherein an adhesive receiving groove configured to receive the structural adhesive is formed at the composite material and is configured to guide a path along which the structural adhesive is coated.

9. The composite mat according to claim 8, wherein a step groove is formed at an end of the composite material disposed adjacent to the adhesive receiving groove in a same plane as the adhesive receiving groove.

10. The composite mat according to claim 7, wherein the structural adhesive is coated between the composite material and the flange disposed inwardly of the vehicle body, as compared to a position where the fastening member is fastened.

11. The composite mat according to claim 1, further comprising a reinforcing member made of metal inserted between the composite material and the woven fabric layer.

12. The composite mat according to claim 1, further comprising deformation guide members having a predetermined diameter inserted between the composite material and the woven fabric layer, wherein the deformation guide members form a lattice structure.

13. A vehicle comprising:
a center floor module;
a front floor module connected to a front portion of the center floor module;
a rear floor module connected to a rear portion of the center floor module; and
a composite mat attached to the center floor module, the composite mat comprising a composite material formed by a plurality of layers, the composite material comprising:
a first polyurethane resin layer;
a first glass fiber mat on the first polyurethane resin layer;
a honeycomb layer on the first glass fiber mat;
a second glass fiber mat on the honeycomb layer;
a second polyurethane resin layer on the second glass fiber mat; and
a woven fabric layer on the second polyurethane resin layer.

14. The vehicle according to claim 13, wherein:
a first surface of the composite material is seated on each fastening surface of frame members constituting floor modules of the vehicle;
a fastening reinforcing member is inserted between a portion of a second surface of the composite material corresponding to the fastening surface and the woven fabric layer; and
a fastening member extends through the woven fabric layer, the fastening reinforcing member and the composite material, and is fastened to the fastening surface.

15. The vehicle according to claim 13, wherein:
the composite material is seated on each fastening surface of frame members constituting floor modules of the vehicle;
a cylindrical fastening reinforcing member is inserted through the woven fabric layer and the composite material; and
a fastening member extends through the fastening reinforcing member, thereby fastening the composite mat to the fastening surface.

16. The vehicle according to claim 15, wherein:
each of the frame members is formed to have a tubular shape while having an opened cross-sectional structure with a side opening portion at one peripheral surface thereof;
a mounting plate is coupled between side closing sections respectively formed at opposite sides of the side opening portion; and
the composite material is seated on and fastened to an upper surface of the mounting plate.

17. The vehicle according to claim 16, further comprising:
a flange formed at an end of each side closing section in accordance with folding of the end toward the side opening portion; and
a structural adhesive coated between the flange and the composite material.

18. The vehicle according to claim 17, further comprising:
an adhesive receiving groove configured to receive the structural adhesive formed at the composite material and configured to guide a path along which the structural adhesive is coated; and
a step groove formed at an end of the composite material disposed adjacent to the adhesive receiving groove in a same plane as the adhesive receiving groove.

19. The vehicle according to claim 13, further comprising a reinforcing member made of metal inserted between the second polyurethane resin layer and the woven fabric layer.

20. The vehicle according to claim 13, further comprising deformation guide members having a predetermined diameter inserted between the second polyurethane resin layer and the woven fabric layer, wherein the deformation guide members form a lattice structure.
